(19) United States
(12) Patent Application Publication
(10) Pub. No.: US 2007/0223501 A1
(43) Pub. Date: Sep. 27, 2007

(54) Method and System for Bidirectional Transmission of Data Between a Data Processing Device and a Router

(75) Inventor: Qi Guan, Wien (AU)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTENGESELLSCHAFT, MUNICH GERMANY (DE)

(21) Appl. No.: 11/628,139

(22) PCT Filed: May 21, 2005
(86) PCT No.: PCT/EP05/05536

§ 371 Date: Nov. 29, 2006

(30) Foreign Application Priority Data
Jun. 3, 2004 (DE) 10-2004-027-060.0

(51) Int. Cl. H04L 12/28

(52) U.S. Cl. 370/401

(57) ABSTRACT

In a method for bidirectional transmission of data between a data processing device and a router data is transmitted over a plurality of sections. Data is transmitted over a first section between the data processing device and an access point via an air interface in accordance with a predefined first data transmission method. The data is transmitted over a second section between the access point and a central control unit via a cable-based connection in accordance with a predefined second data transmission method. The data is transmitted over a third section between the central control unit and the router in accordance with a predefined third data transmission method. The access point has a first layer for data transmission in accordance with the first data transmission method and layers hierarchically above the first layer for data transmission in accordance with the first data transmission method are disposed in the central control unit.

The invention relates to a method for bidirectional transmission of data between a data processing device and a router. The invention further relates to a system for bidirectional transmission of data between a data processing device and a router.

In the wake of the constantly growing demand for packet-switched communication and the likewise increasing need for broadband internet access that is available virtually everywhere, both xDSL technology and WLAN technology are advancing on a global scale. In this case xDSL is the generic term for a digital subscriber line which transmits data in accordance with ADSL, VDSL, HDSL, etc. Above all in domestic applications, xDSL modems in combination with WLAN routers are becoming more and more widely established. WLAN routers of this type are what are referred to as standalone devices which are installed in the user's household and essentially have three central components. Specifically, these are what is referred to as the access point, in the form of the radio interface, what is referred to as the access controller, and the actual data transmission application, in other words what is referred to as the Internet Protocol application. In this case the WLAN router operates in accordance with the IEEE 802.11 standard and therefore has the radio function conforming to 802.11a or 802.11b as well as the functions conforming to 802.1X for authenticating the user and for encrypting the air section of the link. In addition the functions for secure mobility and management, DHCP, IP routing, IP tunneling, 802.1Q trunking and address translation with firewall for the air section, as well as the management of a virtual private network must be ensured.

However, in the domestic application of WLAN routers a number of problems and disadvantages are encountered which, for example, typically occur already during the installation of the WLAN router, whereby it is usually not possible to work with plug-and-play, but instead, depending on setup, as many as several dozen steps are required for the installation, registration and administration of the WLAN router. Moreover, there are no security solutions for a standalone WLAN router because said solutions usually require at least one RADIUS server. It is therefore also impossible to apply a new security mechanism for a WLAN router of said kind. Furthermore there is an exceptionally big problem in the management and maintenance of an ADSL-WLAN router combination because it is comparatively difficult to discover whether a fault is to be ascribed to the ADSL connection or to the WLAN router. The telecommunications company, namely, merely has sovereignty over the xDSL link and consequently cannot support the WLAN router.

For these above-cited reasons, the object underlying the invention is therefore to specify a method and a system for bidirectional data transmission which make it possible to cover the data path between a subscriber terminal device, for example a computer, by means of two different data transmission methods without the switching center losing control over the last connection to the subscriber terminal. According to the invention this object is achieved with regard to the method by means of a method for bidirectional transmission of data between a data processing device and a router in which the data is transmitted over a plurality of sections, wherein
a) the data is transmitted over a first section between the data processing device and an access point via an air interface in accordance with a predefinable first data transmission method;
b) the data is transmitted over a second section between the access point and a central control unit via a cable-based connection in accordance with a predefinable second data transmission method;
c) the data is transmitted over a third section between the central control unit and a router in accordance with a predefinable third data transmission method;
d) wherein the access point has a first layer required for data transmission in accordance with the first data transmission method and the layers hierarchically higher than the layer for data transmission in accordance with the first data transmission method are disposed in the central control unit.

According to the invention the aforementioned object is achieved with regard to the system by means of a system for bidirectional transmission of data between a subscriber terminal, in particular a data processing device, and a router, in which system the data is transmitted over a plurality of sections, wherein
a) an access point is included for the purpose of transmitting the data over a first section to and from the data processing device, said access point having a first layer required for data transmission in accordance with a first data transmission method and an air interface operating in accordance with the first data transmission method as well as an interface module operating in accordance with a second data transmission method;
b) a central control unit is included for the purpose of transmitting the data over a second section to and from the access point, said central control unit having a second layer required for data transmission in accordance with a first data transmission method and if applicable further hierarchically higher layers as well as an interface module operating in accordance with a second data transmission method.

In this way the access point henceforth only comprises what is known as the Physical Layer (also called Layer 1) for data transmission in accordance with the first data transmission method. All higher layers above this that are required for the organization, administration and management of the access point can thus be relocated into the central control unit, with the result that they can be handled on the network operator side. On the one hand this makes it considerably easier to commission and maintain the subscriber-side connection and at the same time results in a greater sovereignty of the network operator over the external components communicating with the network operator's resources and disposed on the subscriber side.

Particularly great simplifications can be achieved if the first data transmission method is a method conforming to IEEE 802.11 and the second data transmission method is a method conforming to xDSL. In this way the xDSL connection can provide the physical data transport for the IEEE 802.11 Layer 2 level. In an enterprise environment the CSMA/CD bus, for example, could provide this data path for the Layer 2 data that is to be signaled through within the framework of the Ethernet environment.

Accordingly, in a logical development of the invention, the first layer in the access point is an IEEE 802.11 PHY layer. Correspondingly, an IEEE 802.11 MAC layer and if applicable higher layers are disposed in the central control unit.

With regard to the embodiment of the system this means that the data is transmitted in accordance with IEEE 802.11 by means of the wireless connection via the air interface. The access point further comprises an XDSL modem or, in an enterprise environment, a CSMA/CD bus controller as an interface module operating in accordance with the second data transmission method.

Further advantageous embodiments of the invention can be derived from the remaining dependent claims.

### Exemplary embodiments of the present invention are explained in more detail with reference to a drawing, in which:

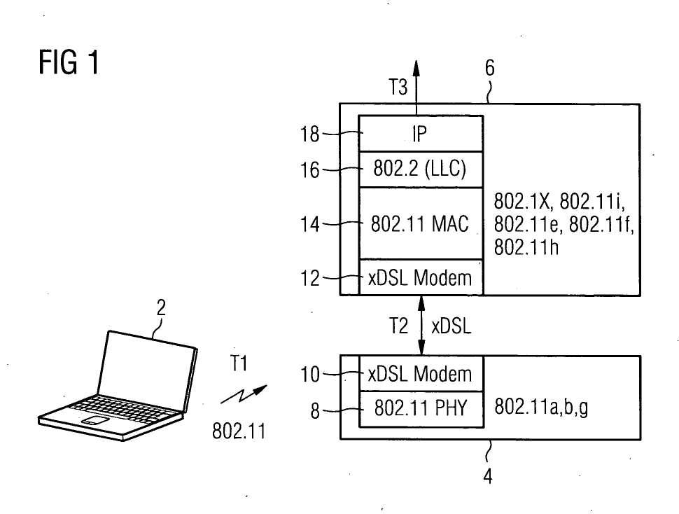

FIG. 1 shows in a schematic representation the functional units of an access point and a central control unit;

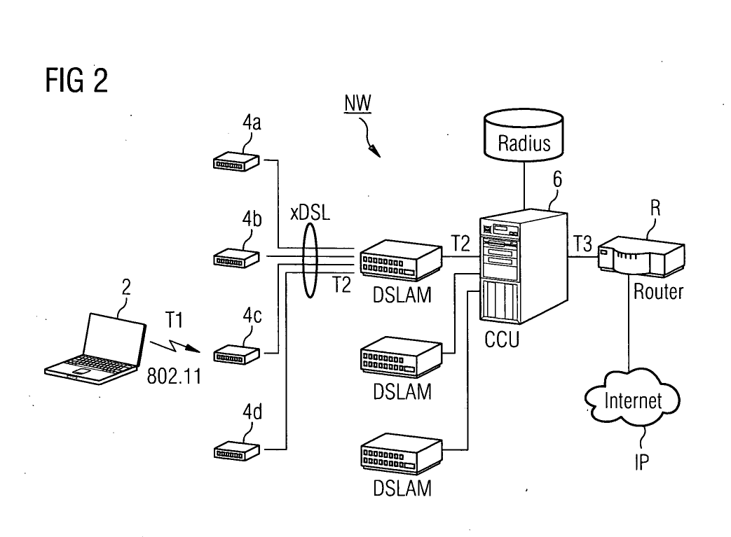

FIG. 2 in a schematic representation a first communication network into which the access point and the central control unit according to FIG. 1 are integrated; and

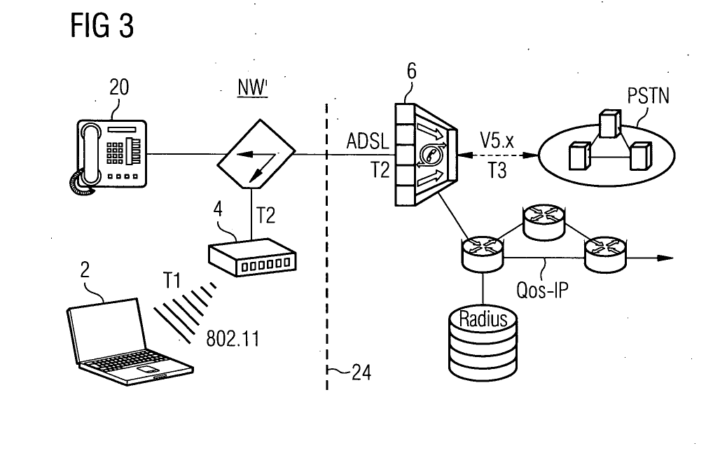

FIG. 3 shows in a schematic representation a second communication network into which the access point and the central control unit according to FIG. 1 are integrated.

FIG. 1 shows in a schematic representation a subscriber terminal 2, an access point 4 and a central control unit 6. In the present example the subscriber terminal 2 is embodied as a laptop which is wirelessly connected to the access point 4 for the purpose of exchanging voice and/or data signals. On this first section Ti of the data transmission the data transmission takes place in accordance with IEEE 802.11, i.e. the laptop is equipped with a corresponding wireless LAN card, e.g. in the form of a PCMCIA plug-in card, and an IEEE 802.11 client.

For the purpose of receiving and transmitting the data via IEEE 802.11, the access point 4 includes the network element 8 required for representing the physical layer 802.11 PHY (Layer 1). The access point further includes an xDSL modem 10 which transports the data that is received or to be transmitted via 802.11 PHY on a second section T2 of the data transmission. Said second section T2 also simultaneously represents the physical boundary between the subscriber-side installation of the access point 4 and the network-operator-side installation of the central control unit 6.

For the purpose of receiving and/or transmitting the payload data, the central control unit 6 likewise includes an xDSL modem 12, but also the higher layers belonging to the physical layer of IEEE 802.11, such as, for example, a Media Access Control layer 14 of the second level as well as a higher layer 16. In the present exemplary embodiment a layer 18 containing components operating in accordance with the Internet Protocol serves for covering a third section T3 of the data transmission to a router that is not shown here in further detail.

In this way a comparatively slim access device 4 is achieved which basically has only the physical layer 8 in terms of WLAN functionality. The IP address of the access device is administered in the MAC layer 14, so the actual LAN switches (e.g. the DSLAMs according to FIG. 2) have a layer 2 data path signaled through via xDSL. The access device 4 can also be connected to the LAN switch via an Ethernet cable, it being possible in this way for the electrical energy supply from the central control unit 6 also to be embodied as a Power over Ethernet connection. This also removes the need on the subscriber side for the generally not particularly visually attractive, detachable connection of a power supply unit to the access device 4. The access device 4 is therefore essentially now only a converter which, in the present exemplary embodiment, connects the wireless data transmission world to the wired data transmission world (radio-to-wire media converter). With its layer 2 functionality 14 and the hierarchically higher layers 16, 18, the central control unit 6 disposed and administrable on the network operator side therefore exercises the hierarchical control on behalf of the access device 4, such as e.g. user authentication in accordance with 802.1X, encryption on the air section, as well as all the remaining management functions of the WLAN and the assurance of the mobility of the user while on the move in the WLAN area.

FIG. 2 now provides, in a schematic representation, an overview of a first communication network NW. The above-described architecture in relation to the configuration and task allocation of the access device 4 and the central control unit 6 is implemented accordingly and shown in detail for the access device 4c. The access devices 4a to 4c are connected to a multiplexer DSLAM (Digital Subscriber Line Access Multiplexer) which represents the connection still within the scope of the second section T2 to the central control unit 6. Also connected to the central control unit 6 is a security management server RADIUS. Disposed on the transport side are a router R and an Internet Protocol backbone IP for the transport on the network side.

FIG. 3 shows, in a schematic representation, an overview of a second communication network NW′ which is likewise equipped with the above-described access device 4 and the central control unit 6. Between the access device 4 and the central control unit 6 there is provided for the second section T2 of the data transmission an ADSL connection which is split by means of a splitter 22 into a voice data connection to a telephone 20 and an exclusive data connection to the laptop 2. As already entered in FIG. 2, in FIG. 3 a dashed line 24 also represents the physical boundary between the equipment disposed on the subscriber side and the equipment disposed on the transport side, for which in this case, intended to be representative of all known transport methods, a V5.x connection for the voice traffic to a public telephone network PSTN and a packet-switched Internet Protocol connection to an IP network with Quality-of-Service features QOS-IP is indicated.

In the setting up/commissioning of a connection of this type between access device 4 and central control unit 6 it is possible to proceed only in a very simple manner, it being possible in particular to set the security policy, which is otherwise time-consuming and complex to set up, on the network side by means of the security server RADIUS. In a first step, the xDSL link between the access device 4 and the carrier-side multiplexer DSLAM must therefore be established first. In a second step, the 802.11 client of the subscriber terminal 2 wirelessly sends requests for associating the 802.11 client with the access device 4, which forwards said association requests via the DSLAM to the central control unit 6.

In the third step it is now provided that the central control unit 6 detects the association request of the client and opens a port for said client. At the same time said port is switched to what is referred to as an unauthorized state so that only data traffic according to IEEE 802.1X is relayed. The usual IP data traffic, such as e.g. DHCP, HTTP, FTP, POP3, etc., is still blocked at this stage. In the fourth step, the access device 4 now answers the association request on 802.1X back to the 802.11 client of the subscriber terminal 2 and requests the latter to declare its identity. The answer from-the 802.11 client directed thereupon contains said identity, which is transmitted via the network to the RADIUS server for the purpose of authentication. In the fifth step, following the authentication check, an ACCEPT or REJECT packet is sent by the authentication server RADIUS to the central control unit 6. In the case of an ACCEPT packet the central control unit 6 sets the previously opened but still unauthorized port to an authorized state, whereupon any data traffic is now transmitted to the access device 4 and the 802.11 client.

1. A method for bidirectional transmission of data between a data processing device and a router, in which method the data is transmitted over a plurality of sections, wherein
a) the data is transmitted over a first section between the data processing device and an access point via an air interface in accordance with a predefined first data transmission method;
b) the data is transmitted over a second section between the access point and a central control unit via a cable-based connection in accordance with a predefined second data transmission method; and
c) the data is transmitted over a third section between the central control unit and the router in accordance with a predefined third data transmission method;
d) with the access point having a first layer for data transmission in accordance with the first data transmission method and layers hierarchically above the first layer for data transmission in accordance with the first data transmission method being disposed in the central control unit.

2. The method of claim 1, wherein the first data transmission method is a method conforming to IEEE 802.11 and the second data transmission method is a method conforming to xDSL.

3. The method of claim 2, wherein the first layer in the access point is an IEEE 802.11 PHY layer, and wherein an IEEE 802.11 MAC layer is disposed in the central control unit.

4. A system for bidirectional transmission of data between a subscriber terminal, in particular a data processing device, and a router, in which system the data is transmitted over a plurality of sections, wherein
a) an access point is included for transmitting the data over a first section to and from the data processing device, said access point having a first layer for data transmission in accordance with a first data transmission method and an air interface operating in accordance with the first data transmission method as well as an interface module operating in accordance with a second data transmission method;
b) a central control unit is included for transmitting the data over a second section to and from the access point, said central control unit having a second layer for data transmission in accordance with a first data transmission method and an interface module operating in accordance with a second data transmission method.

5. The system of claim 4, wherein the air interface transmits the data in accordance with IEEE 802.11 and wherein the interface module operating in accordance with the second data transmission method is an xDSL modem.

6. The system of claim 4, wherein the first layer in the access point is an IEEE 802.11 PHY layer, and wherein an IEEE 802.11 MAC layer is disposed in the central control unit.

7. The system of claim 5, wherein the first layer in the access point is an IEEE 802.11 PHY layer, and wherein an IEEE 802.11 MAC layer is disposed in the central control unit.

8. The system of claim 5, wherein the first layer in the access point is an IEEE 802.11 PHY layer, and wherein an IEEE 802.11 MAC layer and higher layers are disposed in the central is disposed in the central control unit.

9. The method of claim 2, wherein the first layer in the access point is an IEEE 802.11 PHY layer, and wherein an IEEE 802.11 MAC layer and higher layers are disposed in the central control unit.
